(19) United States
(12) Patent Application Publication
(10) Pub. No.: US 2009/0310499 A1
(43) Pub. Date: Dec. 17, 2009

(54) DATA COMMUNICATION WITH CONTROL OF THE TRANSMISSION RATE OF DATA

(75) Inventors: Eric Perraud, Tournefeuille (FR); Bertrand Deleris, Seysses (FR)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 12/375,858

(22) PCT Filed: Aug. 1, 2006
(86) PCT No.: PCT/IB06/54089

§ 371 Date: Jan. 30, 2009

(51) Int. Cl. H04L 12/26

(52) U.S. Cl. 370/252; 370/328

(57) ABSTRACT

A data communication network, includes a transmitting node; a receiving node; and a connection between the transmitting node and the receiving node. The receiving node is arranged to process data received from the transmitting mode via the connection. The network further includes a first measuring unit which is connected with a measuring input to the receiving node. The first measuring unit can determine a first parameter value forming a measure for the data processing capacity of the receiving node. A calculator has an input connected to an output of the measuring unit and can derive from the first parameter value a second parameter value forming a measure for the transmission rate of data from the transmitting node to the receiving node. A transmission control unit has a transmission control input connected to a calculator output and a transmission control output connected to the transmitting node. The transmission control unit can control a transmission of data via the connection based on the determined measure for the transmission rate.

### FIELD OF THE INVENTION

This invention relates to a data communication network. The invention further relates to a receiving node and a transmitting node. The invention also relates to a system for controlling transmitting data. The invention further relates a method for transmitting data. The invention also relates to a computer program product.

### BACKGROUND OF THE INVENTION

Data communication networks are generally known. For example, wireless mobile data communication networks typically include a number of base stations which can establish a wireless, radio connection to a user equipment, e.g. a mobile telephone. The base station is connected to a wired network, generally referred to as a core network.

For example, European Patent Application Publication EP 1505756 discloses a wireless communication system which includes a plurality of base stations. The base station serves a cell in which a plurality of individual users may be located. Each user has an individual user equipment (UE) which can be connected to the base station via a wireless connection. Each UE produces a measure of the quality of a downlink channel from the base station to the UE. Based on this measure and on a CQI (Channel Quality Indicator) mapping table, the UE reports the CQI value to the base station. The base station sets parameters of the wireless connection based on the reported CQI value.

However, a disadvantage of the data communication network disclosed in this prior art document is that the connections cannot be controlled accurately since the CQI provides an indication of the quality of the wireless connection only.

### SUMMARY OF THE INVENTION

The present invention provides a data communication network as described in the accompanying claims. The invention further provides a receiving node according to claim 14 and a transmitting node according to claim 15. The invention also relates to a system according to claim 18. The invention also relates to a method for transmitting data according to claim 19. The invention also relates to a computer program product according to claim 20.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings.

FIG. 1 schematically shows a block diagram of a communications network in accordance with one embodiment of the invention, given by way of example,

FIG. 2 schematically shows a first example of a wireless telecommunications network in which the example of FIG. 1 may be implemented.

FIG. 3 schematically shows a second example of a wireless telecommunications network in which the example of FIG. 1 may be implemented.

### DETAILED DESCRIPTION OF EXAMPLES OF EMBODIMENTS

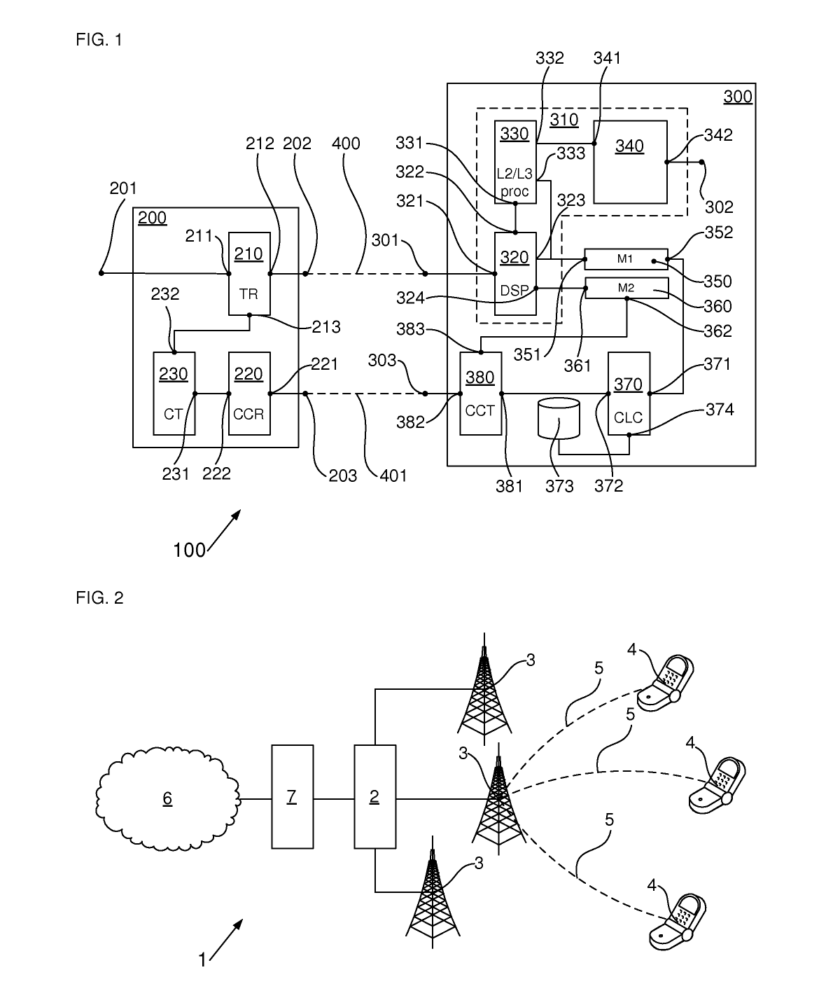

The example of a data communication network 100 shown in FIG. 1 includes a transmitting node 200 and a receiving node 300. The transmitting node 200 and the receiving node 300 are connected via a connection 400. The network 100 further includes a first measuring unit (M1) 350, a calculator (CLC) 370 and a transmission control unit (CT) 230.

In the example of FIG. 1, the transmitting node 200 has an input 201 via which data can be received from other nodes (not shown in FIG. 1). In this example, a transmitting node output 202 of the transmitting node 200 is connected to a receiving node input 301 of the receiving node 300. Data can be transmitted from the transmitting node 200 to the receiving node 300 via the connection 400. The receiving node 300 may subsequently process the data received from the transmitting node via the connection 400, for example transmit the data to another node in the network or output the data in a for humans perceptible form at a user interface, such as a display.

The measuring unit 350 is connected to a measurement port of the receiving node 300. In the example of FIG. 1, for instance, the first measuring unit 350 is connected with a measuring unit input 351 to a measuring port 323 of a component of the receiving node 300, more in particular to a port of a module of a digital signal processor (DSP) 320 which forms a part of a modem (MOD) 310.

The calculator 370 is connected to the measuring unit 350. The calculator 370 may, as shown in FIG. 1, be connected with a calculating input 371 to a measuring output 352 of the measuring unit 350. The transmission control unit 230 may be connected to the calculator 370. In the example of FIG. 1, for instance, the transmission control unit 230 is communicatively connected to the calculator 370 and can receive at a transmission control input 231 data outputted at a calculating output 372 of the calculator 370, in this example over a control channel 410, via a control channel transmitter (CCT) 380 and a control channel receiver (CCR) 220, as is explained below in further detail.

In the example of FIG. 1, the transmission control unit 230 is connected with a transmission control output 232 to a control input 213 of a transmitter (TR) 210 in the transmitting node 200.

The first measuring unit 350 may determine a measured parameter value forming a measure for the data processing capacity of the receiving node 300. The calculator 370 may receive data representing the parameter values from the measuring unit 350 and derive, from the measured parameter value, a calculated parameter value forming a measure for a parameter of the connection 400 from the transmitting node 200 to the receiving node 300, such as the transmission rate or a size of data packets. Based on the calculated parameter value, the transmission control unit 230 may control a transmission of the data, more in particular the transmission rate or the packet size of the data, via the connection. In the example of FIG. 1, the CT 230 can control the connection between the transmitting node 200 and the receiving node 300 via the control input 213.

Thereby, an accurate control of the transmission of the data may be obtained. Accordingly, a more optimal transmission of the data may be obtained, since the transmission of the data may be controlled such that the receiving node 300 does not receive more data than can be processed by the receiving node. Thereby, the chance that the receiving node is not able to process the data and discards the data may be reduced and the chance that transmitted data is lost, may be reduced as well.

Furthermore, in case the transmitting node 200 is connected to more than one receiving node, as for instance in the example shown in FIG. 2, an improved usage of the resources of the transmitting node may be obtained, since the transmitting node 200 can be controlled depending on the available processing capacity of the receiving nodes 300. Hence, for example, a small part of the resources of the transmitting node 200 can be used in case the available processing capacity of the respective receiving node 300 is small and a higher part of the resources of the transmitting node 200 can be used in case the available processing capacity of the respective receiving node 300 is higher.

Also, the overall data transmission rate may be increased. For example, the transmitting node 200 may transmit more data to receiving nodes 300 with a higher data processing capacity and transmit less data to receiving nodes 300 with a lower data processing capacity. Thereby, the total flow of data from the transmitting node to the receiving nodes may be less limited by the data processing capacity of the receiving nodes.

The data may be transmitted from the transmitting node 200 to the receiving node 300 in any suitable manner. For instance, as shown in FIG. 1, the transmitting unit 200 may include a transmitter 210. The transmitter 210 includes a transmitter input 211 which is connected to the input 201 of the transmitting node 200 and a transmitter output 212 which is connected to the output 202 of the transmitting node 200. The transmitter 210 may, for example, receive the data from the input 201, convert the data in a type suitable to be received by the receiving node 300 and transmit the converted data to the receiving node 300 via the transmitter output 212. The receiving node 300 may, as shown in FIG. 1, for example include a modem 310 connected to the receiving node input 301 which can receive the data and convert the received data into a type of data suitable to be processed downstream of the modem 310. In this respect it should be noted, the term ‘modem’ as used in this application refers to a device which converts a received signal into a form suitable for a communication system. The modem may, for example, convert a received signal into a form suitable to be processed by upper layers of a communication protocol. The modem may, for example, use hardware resources, such as one or more processors and memories to perform demodulation, decoding functions and to process low level protocol layers and may execute software.

In the example of FIG. 1 the modem 310 includes a digital signal processor (DSP) 320 which is connected with a DSP input 321 to the receiving node input 301. The DSP may, for example, perform physical layer functions, for example those defined in OSI layer 1. The modem 310 further includes a network and data link processor (L2/L3) 330. A DSP output 322 is connected to an L2/L3 input 331. The network and data link processor L2/L3 may, for example, perform network layer and data link layer functions, for example those defined in OSI layer 2 and layer 3. The modem 310, as shown in FIG. 1, further includes an application processor 340. The application processor 340 may for example perform functions of layers above the network layer and the data link layer, such as OSI layer 4 and higher. The application processor 340 may, for example, process the received data, and for example perform instructions included in the data or convert the received data. An output 342 of the application processor 340 is connected to a user interface 302. The application processor 340 may output at the user-interface data in a for humans perceptible form. For example, in case the received data represent audio and/or video, the application processor 340 may output audio and/or video signals at the user interface 302.

It should be noted that between the receiving node input 301 and the modem 310 further devices may be present, which in FIG. 1 are omitted, for sake of clarity. For example between the receiving node input 301 and the modem 310 a receiver front end may be present which converts the incoming signals into baseband signals. Also, in the example of FIG. 1, the measuring unit 350 are shown as a device outside the modem 310 and separate from the DSP 320 and the L2L3 processor 330. However, the measuring unit 350 may be included in the modem 310. In the example of FIG. 2, the calculator 370 is shown as a device separate from the DSP 320 and the L2L3 processor 330. However, the calculator 370 may be included in the modem 310.

The first measuring unit 350 may determine any parameter value suitable as a measure for the processing capacity of the receiving node 300. For example, the first measuring unit 350 may determine a measured parameter value which forms a measure for the amount of data which is being processed by the receiving node 300 per unit of time or another suitable parameter value.

The first measuring unit 350 may, for example, determine a parameter value forming a measure for the load of receiving node 300, such as the average load and/or the peak load of the receiving node 300. The load forms a measure for the amount of work that a device is doing, and may be for example defined as the amount of work that a device is doing relative to the maximum amount of work the device can do (e.g. relative to the processing capacity of the device). The load may, for example, be the processing load of a processor or the traffic load through an input/output device in the receiving node 300.

For example, the measuring unit 350 may determine the idle time of the receiving node, or of a unit thereof, during a unit of time, for example during a frame and output the determined amount to the calculator 360, such as the null task.

The first measuring unit 350 may, for example, determine a parameter value forming a measure for the load average, i.e. the load averaged over a period of time. For example, the first measuring unit may determine a parameter value forming a measure of the time the receiving node, or a part thereof, is active relative to the total period of time.

The first measuring unit 350 may, for example, be arranged to determine a parameter value forming a measure of the data processing capacity of a component of the receiving node 300. The component may, for example, be part of chain of components, for example of a linear, not branched, chain of components connected to the receiving node input 301. For example, the first measuring unit 350 may be arranged to determine a parameter value forming a data processing capacity of a bottleneck component which defines the maximum processing capacity of the receiving node. For example, the first measuring unit 350 may determine a parameter value of a component which, in a direction of the data flow, is provided downstream of the receiving node input 301 and upstream of a processor. Thereby, the load can be measured accurately, since the data flow downstream of the component is restricted by the data processing capacity of the component.

For instance, in the example of FIG, 1, the data flow to the application processor 340 is limited by the flow through the DSP 320 and the L2/L3 processor 330. In the example of FIG. 1, the first measuring unit 350 is connected to the DSP 320, via measuring port 323, and to a L2L3 processor 330, via a measuring port 333. The first measuring unit 350 can measure the data processing capacity, for example the load, of the DSP 320. Hence, the data processing capacity of the receiving node 300 can be measured accurately and in a simple manner, since the flow of data, and hence the data processing capacity of the application processor 340 and of the modem 310, is limited by the capacity of the DSP 320 and the L2L3 processor 330.

The first measuring unit 350 is connected to the calculator 370 and outputs information representing the first parameter value to the calculator 370. The calculated parameter value may, for example, form a measure for one or more parameters of the connection 400 controlled by the transmission controller 230. However, the calculated parameter value may form a measure for a parameter different from the parameter or parameters controlled by the transmission controller 230. The parameters of the connection 400 controlled by the transmission controller 230 may for example include one or more of the group consisting of: data packet rate, data packet size, cyclic redundancy check (CRC), data compression or other suitable parameters of the connection 400.

The calculator 370 may determine the calculated parameter value, which forms a measure for the transmission rate in any suitable manner. The calculator 370 may, for example, be connected to a memory 373 in which data is stored. The data in the memory 373 may represent one or more algorithms suitable to determine a calculated parameter value forming a measure for transmission rate from the received measured parameter value, for example those of equations (1) to (6) below .

Based on the measured parameter value, the calculator 370 may determine a value for a parameter of the connection 400, such as a measure of the rate of data to be transmitted. However, the calculator may also determine values of other parameter of the connection 400, such as for example of one or more of the group consisting of: data packet rate, data packet size, parameters relating to cyclic redundancy check (CRC) or data compression or other suitable parameters of the connection 400. The data presented at the output 352 may for example represent the duration of the

Null_task or the time when the modem or a part thereof, such as the DSP 320 and/or L2L3 processor 330 is in idle mode. The calculator 370 may derive from duration of the Null_task an amount of data that can be received by the receiving node, for example using the mathematical algorithm:

Null_task=A−B·D_{received} (1)

in which D_{received} represents the amount of received data, A represents the total available number of clock cycles of the DSP per unit of time reduced by the number of clock cycles used by tasks independently of the data rate. Depending on the mode in which the receiving mode is operating, the number of tasks to be performed by the DSP independent of the amount or data may differ and hence the value of A may set to a different value. B is a predetermined constant which represents the number of clock cycles required to process a received unit of data. The calculator 370 may, for example, determine a value of a change, such as increase or decrease, in the amount of data the receiving node 300 can receive over the measurement duration unit of the first measurement unit 350. This value may, for example, be a global data amount per measurement period of the first measuring unit 350, and/or a global data-rate, and/or a maximum size of units of data and/or a maximum number of data packets whose size is unchanged or known and/or, any other parameter value suitable to control the transmission rate.

The calculator 370 may, for example, determine an average rate of data. The calculator 370 may, for example, compare the Null task value outputted by the first measuring unit 350 with a predetermined upper threshold, and/or a predetermined lower threshold lower than the upper threshold. Without wishing to be bound to any theory, it is believed that if the Null task duration exceeds the predetermined upper threshold, this implies that the modem has been idle for significant periods of time and may therefore process more data. The calculator 370 may then determine the amount of additional data D_{add} with which the average amount of data can be increased, for example using the mathematical relationship:

$${D}_{add} = \frac{{F}_{mod} \cdot T}{B} \cdot ( M - \frac{Null\_task}{{F}_{mod} \cdot T} ) \qquad ( 2 )$$

in which F_mod represents the modem frequency, T represents the measurement period of the measurement unit 350 and consequently the period of time during which the additional data can be sent. M is a constant set to a value in the range above 0 up to and including 1 and may, for example, be set to a value less than 1, such as 0.9, to ensure a margin which prevents an overload.

In case the Null task duration is below the predetermined lower threshold, without wishing to be bound to any theory, it is believed that this is an indication that the modem becomes overloaded and there is a chance that data will be discarded. Based on the difference between the determined null task duration and the threshold, the calculator 370 can determine a suitable amount D_{red} with which the average amount data to be sent has to be reduced, for example using the mathematical relationship:

$${D}_{red} = \frac{{F}_{mod} \cdot T}{B} \cdot ( \frac{Null\_task}{{F}_{mod} \cdot T} - M ) \qquad ( 3 )$$

in which F_mod represents the modem frequency, T represents the period of time during which the additional data can be sent. M is a constant set to a value in the range above 0 up to and including 1 and may, for example, be set to a value less than 1, such as 0.9, to ensure a margin which prevents an overload.

The measurement unit 350 may also measure when tasks or actions of a certain type are completed. Accordingly, the first measurement unit 350 may, for example, measure when tasks or actions on which a time limit is imposed are completed. For example, many network standards impose deadlines to be met and actions to be complete at some predefined instants. As an example, the 3G standard requires uplink and downlink power control to be complete within very short response times. For example, the first measurement unit 350 may measure when tasks or actions which are most time-critical are completed.

The calculator 370 may calculate a maximum for the rate of transmitted data. The calculator 370 may, for example, compare a completion time T₁ of a task determined by the measuring unit 350 with a predetermined target time T₀ and determine an (increase of the) maximum packet size S from the difference between the target time T₀ and the determined time T₁ of a task involved in the time-critical path for example using the mathematical relationship:

$${S}_{i} = \frac{Ti - C}{D} \qquad ( 4 )$$

in which C represents the delay independent of received data amount to complete the time-critical action i and D the time delay per received data.

The amount sᵢ with which the maximum size S of the unit of data, e.g. the packet, has to be changed, may then be calculated, by:

$${s}_{i} = \frac{{T}_{0} - {T}_{1}}{B} \qquad ( 5 )$$

The calculating unit 370 may perform such a process for the time-critical actions or tasks, and transmit to the transmission control unit 230 a determined value selected from the sequence, for example using the mathematical relationship:

ΔS=min (sᵢ(1). . . sᵢ(n)) (6)

Where I is the index of the time-critical action/task.

The data communication network 100 may include further measuring units, for instance for determining a parameter forming a measure for the quality of the connection 400, such as a signal to noise ratio, a bit error rate or otherwise. For instance in the example of FIG. 1, a connection measuring unit 360 is connected with an input 361 to a connection measuring port 324 of the DSP, via which the connection measuring unit 360 can determine relevant parameters. The connection measuring unit 360 may, for example, measure parameters suitable to determine a channel quality indicator (CQI), as for example defined in the 3GPP specification.

As shown in the example of FIG. 1, the network 100 may further include control channel 401 for transmitting control data from the receiving node node 300 to the transmitting node 200. In the example of FIG. 1, a control channel port 303 of the receiving node 300 is connected to a control channel port 203 of the transmitting node 200. For example, the measuring units 360 and/or the calculator 370 may transmit D_{red}/D_{add}, and ΔS information over the control channel 401. In the example of FIG. 1, the measuring units 350,360 are respectively connected indirectly and directly with outputs 352 and 362 to inputs 381,383 of a control channel transmitter (CCT) 380. The output 382 of the control channel transmitter (CCT) 380 is connected to the control channel 401. An input 221 of a control channel receiver (CCR) 220 is connected to the control channel. The CCR 220 can receive via the control channel 401 the determined parameter values from the CCT 380. An output 222 of the CCR 220 is connected to an input 231 of the transmission control unit (CT) 230. Accordingly, the transmission control unit (CT) 230 can receive the calculated parameter value and, optionally the parameter value forming a measure for the quality of the data connection 400. Based on the received parameter values, the transmission control unit 230 may control the data transmitter (TR) 210. The transmission control unit 230 may, for example, control the Baud rate, the size of transmitted data per receiver node 300, the occurrence rate of packet transmissions per receiver nodes. The transmission control unit 230 may, for example, schedule data transmissions in such a manner that it optimizes the overall traffic, based on parameter values received from two or more receiving nodes 300.

The network 100 may be any suitable type of network. The example of FIG. 2, for example, is a wireless telecommunication network, more in particular a mobile telephone network. The network 1 shown in FIG. 2 includes radio network controller (RNC) 2, base stations 3, and a core network 7. The RNC 2 is connected a number of base stations 3. The base station 3 can be connected to user equipments 4 via a connection 5. In this example, the connection 5 is a wireless connection, and the data communication network 1 is a wireless data communication network. More in particular, the network 1 may be a Universal Mobile Telecommunications System (UMTS) network or other 3G mobile data communication network. In the example of FIG. 2, the core network 5 is connected to a further network 6, which may, for example, be the Internet.

The transmitting node 200 may, for example, be implemented in a base-station 3 and the receiving node 300 may be implemented in a user equipment, such as a mobile telephone, handheld computer, personal digital assistant or other device suitable to interact with an individual. The receiving node 300 thus forms an end node of the mobile telephone network 1. A network end node generally refers a node, i.e. a physical or logical network device that forms an end of a network. Such a network end node can be the actual end of a network, such as a computer at home or a mobile telephone.

The connection 400 may be any suitable type of connection. The connection 400 may, for example, be a connection shared by two or more receiving nodes. The connection 400 may, for example, a High-Speed Downlink Packet Access (HSDPA) network connection, such as the High Speed Physical Downlink Shared Channel (HS-PDSCH) or other type of 3.5 G network connection. Also, the control channel 401 may be any suitable type of channel. The control channel may, for example, be a Physical Control Channel(. For example, in a HSDPA network, the user equipment may transmit a data packet via a modified High Speed Dedicated Physical Control Channel (HS-DPCCH)in which the parameter value is included. For example, the current HSDPA standard HS-DPCCH data packet may be modified, to reduce the number of bit allocated to the acknowledgement and use a number of bits to transmit the parameter values to the transmitting node 200.

The received data may for example represent audio and/or video. However, the received data may also represent other information, for example instructions for the application processor which enable software applications to be executed by the application processor, files being transferred to the receiving node, hypertext documents, positional data such as Global Positioning System information, or other suitable types of information.

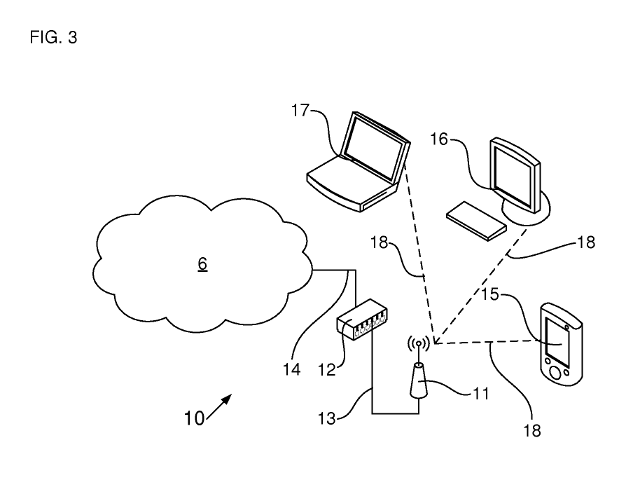

The network, as is for example shown in FIG. 3, may be a wireless local area networks (WLAN),such as a WLAN complying with a member of the IEEE family of standards 802.11. The example shown in FIG. 3 includes users equipments, in this example a laptop 17, a personal computer 16 and a personal digital assistant 15. The user equipments are connected via a wireless connection 18 to a wireless access point11. The wireless access point 11 is connected via wired connections 13,14 and a hub 12 to a network 6, such as for example the Internet or a local area network.

The invention may also be implemented in a computer program for running on a programmable device, at least including code portions for performing steps of a method according to the invention when run on a programmable apparatus, such as a programmable device or enabling a programmable apparatus to perform functions of a device or system according to the invention. For example, the receiving node 300 may include a DSP module which includes hardware which can execute DSP software. Such a computer program may be provided on a data carrier, such as a CD-rom or diskette, stored with data loadable in a memory of a programmable device, the data representing the computer program. The data carrier may further be a data connection, such as a telephone cable or a wireless connection.

In the foregoing specification, specific examples of embodiments of the invention have been described. It will, however, be evident that various modifications and changes may be made therein without departing from the broader spirit and scope of the invention as set forth in the appended claims. For example, the measuring units 350,360, the calculator 370 and transmission control unit 230 may be provided at any suitable position in the network 100. In the example of FIG. 1, for instance, the transmitting node 200 includes the transmission control unit 230. The receiving node 300 includes the units 350,360 and the calculator 370. However, other configurations are also possible. For example, the receiving node 300 may include measuring units which are connected to a calculator in the transmitting unit 200. Also, the network may be one or more of: a wireless data communication network, a wireless telecommunications network. The network may, for example, be a wireless network which complies with the 3GPP specifications and/or International Standards Organisations Standard 802 and/or Bluetooth and/or Zigbee and/or TCP-IP (transmission control protocol-internet protocol) and/or Code Division Multiple Access (CDMA) such as Interim Standard 95 of the Telecommunications Industry Association (TIA).

Also, the invention is not limited to physical devices or units implemented in non-programmable hardware but can also be applied in programmable devices or units able to perform the desired device functions by operating in accordance with suitable program code. It should be understood that all device described herein may be implemented either in silicon or another semiconductor material or alternatively by a software code representation of an article of manufacture of silicon or another semiconductor material.

Furthermore, devices may be physically distributed over a number of apparatuses, while functionally operating as a single device. For example, the digital signal processor 320 or the L2L3 processor may include a number of separate printed circuit boards, with integrated circuits mounted thereon, connected such that they form a digital signal processor or a L2L3 processor. Also, in the example of FIG. 1, one application processor 340 is shown, however the receiving unit 300 may include more than one application processor or no application processor at all. Also, although referred to as receiving node, it will be apparent that the receiving node 300 may also transmit data to the transmitting node 200.

Also, devices functionally forming separate devices may be integrated in a single physical device. For example, the measuring units 350,360 and the calculator 370 may be integrated in a processor or be implemented as a processor which can execute measuring and/or calculating software stored in a memory connected to the processor. Also, the CCT 380 may be included in the modem 310. Also, for example, the DSP 320, the network and data link processor 330 and the application processor 340 may be implemented as a single central processing unit connected to a memory in which program code is stored which enables the central processing unit to perform the functions of the DSP 320, the network and data link processor 330 and the application processor 340.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the words ‘a’ and ‘an’ shall not be construed as limited to ‘only one’, but instead are used to mean ‘at least one’, and do not exclude a plurality. The words ‘connected’, ‘connection’ and the like are not limited to physical direct links but instead are used to mean any communicative connection, both direct and indirect connections, which may be wireless or wired connection. The mere fact that certain measures are recited in mutually different claims does not indicate that a combination of these measures cannot be used to advantage.

1. A data communication network comprising:
a transmitting node;
a receiving node; and
a connection between the transmitting node and the receiving node;
said receiving node being arranged to process data received from the transmitting mode via said connection;
a first measuring unit connected with a measuring input to said receiving node, for determining a first parameter value forming a measure for the data processing capacity of the receiving node, said first parameter value being the idle time of at least a component of the receiving node;
a calculator having an input connected to an output of the measuring unit, for deriving from the first parameter value a second parameter value forming a measure for a parameter of the connection; and
a transmission control unit having a transmission control input connected to a calculator output and a transmission control output connected to said transmitting node, for controlling a transmission of data via said connection based on the determined measure for the transmission rate.

2. A data communication network as claimed in claim 1, wherein said first parameter value forms a measure for the load of the receiving node.

3. A data communication network as claimed in claim 1, wherein said first parameter value forms a measure for the data processing capacity of a component of the receiving node.

4. A data communication network as claimed in claim 3, wherein said first parameter value forms a measure for the data processing capacity of a modem of the receiving node or of a component of said modem.

5. A data communication network as claimed in claim 1, further including a second measuring unit for determining a third parameter forming a measure for the quality of the connection, such as a signal to noise ratio, a bit error rate or otherwise.

6. A data communication network as claimed in claim 1, wherein said network is one or more of:
a wireless data communication network, a wireless telecommunications network.

7. A data communication network as claimed in claim 6, wherein said receiving node is an end node of the network, and, optionally, said receiving node is a user equipment, for example a mobile telephone or a personal digital assistant.

8. A data communication network as claimed in claim 1, wherein said transmitting node includes said transmission control unit.

9. A data communication network as claimed in claim 1, wherein said parameter of the connection includes the transmission rate of data from the transmitting node to the receiving node and/or the size of units of data or transmission rate of data packets.

10. A data communication network as claimed in claim 1, wherein said transmission control unit is arranged to control at least a Baud rate of a transmission of data from the transmitting node to the receiving node or data packet size or transmission rate of data packets.

11. A data communication network as claimed in claim 1, wherein said connection includes a control channel for transmitting control data from the receiving node to the transmitting node and said first measuring unit and/or said processor are connected to said control channel, for transmitting said first parameter value or said second parameter value to the transmitting node over the control channel.

12. A data communication network as claimed in claim 1, wherein said second parameter value represents a change in the amount of data said receiving node can receive via said connection.

13. A data communication network as claimed in claim 12, wherein additional data value computed by the calculator is read by a Control Channel transmitter and sent to the transmitter node.

14. A receiving node for in a data communication network as claimed in claim 1.

15. A transmitting node for in a data communication network as claimed in claim 1.

16. A device for measuring parameters of a receiving node, comprising:
a first measuring unit connectable with a measuring input to a measurement port of said receiving node, for determining a first parameter value forming a measure for the data processing capacity of the receiving node, said first parameter value being the idle time of at least a component of the receiving node; and
a calculator having an input connected to an output of the measuring unit, for deriving from the first parameter value a second parameter value forming a measure for a parameter of the connection, said calculator further including an output, for outputting said second parameter value.

17. A transmission control unit comprising:
a transmission control input for receiving a second parameter value forming a measure for a parameter of a connection between a transmitting node and a receiving node;
a signal generator for generating control signals suitable to control a transmission of data via said connection based on the determined measure for the transmission rate; and
an output connected to said signal generator for outputting said control signals.

18. A system for controlling a transmission of data from a transmitting node to a receiving node, said system comprising:
a first measuring unit connectable to said receiving node, for determining a first parameter value forming a measure for the data processing capacity of the receiving node, said first parameter value being the idle time of at least a component of the receiving node;
a calculator connected to the measuring unit, for deriving from the first parameter value a second parameter value forming a measure for a parameter of the connection; and
a transmission control unit connectable to said transmission node, for controlling a transmission of data via said connection based on the determined measure for the transmission rate.

19. A method for transmitting data, comprising:
transmitting data from a transmitting node to a receiving node in a data communication network;
processing the data by the receiving node;
determining a first parameter value forming a measure for the data processing capacity of the receiving node, said first parameter value being the idle time of at least a component of the receiving node;
deriving from the first parameter value a second parameter value forming a measure for a parameter of the connection; and
controlling a transmission of data via said connection based on the determined measure for the transmission rate.

20. A computer program product, including program code portions for performing a method as claimed in 19, when run on a programmable apparatus.
